(19) United States
(12) Patent Application Publication
(10) Pub. No.: US 2014/0201005 A1
(43) Pub. Date: Jul. 17, 2014

(54) MOBILE ADVERTISING SYSTEM AND METHOD

(71) Applicant: Amr Khaled Shady, Bedford (CA)

(72) Inventor: Amr Khaled Shady, Bedford (CA)

(21) Appl. No.: 13/743,342

(22) Filed: Jan. 17, 2013

(51) Int. Cl. G06Q 30/02

(52) U.S. Cl. CPC G06Q 30/0267
USPC 705/14.64

(57) ABSTRACT

Disclosed is a mobile advertising system comprising a database comprising a plurality of advertising organization entries, each advertising organization entry representing an advertising organization, each advertising organization entry associated with at least one competitor telephone number and at least one executable advertisement file, an advertisement file comprising either an active or an inactive advertisement file and an advertising organization entry associated with at least one active advertisement file referred to as an active advertising organization entry, a processor for retrieving, upon determining that a number dialed on a telephonic device is a competitor telephone number associated with at least one active advertising organization, an active advertisement file out of the at least one active advertisement file that corresponds to one of the at least one active advertising organization that corresponds to the competitor telephone number and an execution engine for executing the retrieved active advertisement file on the telephonic device.

### BACKGROUND

The present invention relates to various advertising systems and methods adapted for wireless handheld devices and, more particularly, relates to a computer-implemented advertising system and method that displays advertisements on wireless handheld telephonic devices, such as smartphones, based on competitor information.

Electronic media advertisements, owing to the widespread use of the mobile wireless communication, have now made their way into wireless handheld devices such as, cellular or mobile phones, especially, smartphones, and tablets and are no longer meant for just televisions, the Internet, and radio. These advertisements on phones are generally displayed or played during call wait times, application loading times, or delivered as text or multimedia messages (a.k.a. SMS spamming). Advertising on mobile devices is not as saturated as the advertising is on other platforms such as the aforementioned television, the Internet, and radio. Although, one might say that smartphones are Internet-enabled and therefore the advertising on the Internet is equivalent to the advertising on smartphones. But, the fact of the matter is, there is not much penetration of advertisements on these devices because in smartphones (or tablets), mostly, in lieu of conventional internet browsers, computer applications are used, which inherently have lesser scope for advertising compared to websites. Advertising on mobile devices is relatively an ‘untapped’ territory and is therefore very much open to innovation.

### SUMMARY

An embodiment of the present invention comprises a mobile advertising system comprising a database listed with a plurality of advertising organization entries wherein, an advertising organization entry represents an advertising organization registered therewith. Each advertising organization is associated with at least one competitor telephone number and at least one advertisement file. An advertising file comprises either an active or an inactive advertisement file based one of the factors or the combination of factors comprising threshold number, stock number or expiry date. An advertising organization associated with at least one active advertisement file referred to as an active advertising organization. The advertising system further comprises a processor, which is in communication with the database, disposed within a telephonic device. The advertising system is configured such that, when a user dials a number on the telephonic device, the processor parses the database for a match between the dialed number and a competitor telephone number. Upon match, the processor determines whether or not the competitor telephone number is associated with at least one active advertising organization. If so, the telephone call to the user-dialed number is terminated following which, one of the active advertisement files associated with the at least one active advertising organization is retrieved. The retrieved active advertisement file is executed by an execution engine so as to render an advertisement on the telephonic device.

Other objects and advantages of the embodiments herein will become readily apparent from the following detailed description taken in conjunction with the accompanying drawings.

### BRIEF DESCRIPTIONS OF THE DRAWINGS

FIG. 1 is a block diagram depicting the components on the organization side of the mobile advertising system according to the preferred embodiment of the present invention.

FIG. 2 is a block diagram depicting the components on the user side of the advertising system according to the preferred embodiment of the present invention.

FIG. 3 is a block diagram depicting the components of the processor in functional relation with each other and with the other components of the advertising system according to an embodiment of the present invention.

FIGS. 4A and 4B together comprise the flowchart of the advertising method according to the preferred embodiment of the present invention.

### FIGURES

### Reference Numerals

10 . . . Mobile Advertising System
12 . . . Database
14 . . . Processor
16 . . . Number Module
18 . . . Checking Module
20 . . . Call Termination/Initiation Module
22 . . . Retrieval Module
24 . . . Registered Telephonic Device
26 . . . User Interface
28 . . . Selection Module
30 . . . Execution Engine

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The present invention comprises a computer-implemented mobile advertising system for delivering advertisements on wireless telephonic devices such as, cellular or mobile phones, especially smartphones, and tablets based on competitor information. Delivering advertisements based on “competitor information” ensures that the advertisements so delivered are relevant and are therefore targeted. The term “advertisement” refers to an electronic media content communicating a product/service purchase offer made by an advertising organization wherein, the product/service offer is provided with an option to ‘accept’ and ‘reject’ the same. The media content preferably comprises audio content wherein, the options, viz., accept and reject are communicated through the keys of physical or virtual keypad on a telephonic device. However, in other embodiments, interactive image and multimedia (or video) content may be employed in lieu of the audio content for advertising. The competitor information comprises telephone numbers of competitor organizations wherein, the competitor organizations, as the term suggests, comprise competitors of the advertising organization. The advertising system is basically a third-party service provider meant to benefit two parties, viz., the organizations, which will be referred to as “advertising organizations,” and the users, which comprise the general public. A user needs to download and install the advertising system as a smartphone application within the telephonic device thereof in order to make use of the same. An organization, on the other hand, needs to register with the advertising system in order to be a part thereof.

The advertising system comprises an organization registration interface, which enables an organization to register therewith. More particularly, the organization registration interface comprises a plurality of data input fields within which, specific information (i.e., “registration information”) pertaining to an organization is to be received. For instance, the information needed for registration may comprise the name of the organization, contact details, product/service category, industry, etc. Additionally, a registration fee might have to be paid by the organization towards the registration thereof. In a similar manner, in one embodiment, the user might also need to register with the advertising system so as to render the advertising system installed within his/her telephonic device functional. Similar to organization registration interface, a user registration interface is provided by the advertising system for receiving the registration information of the user.

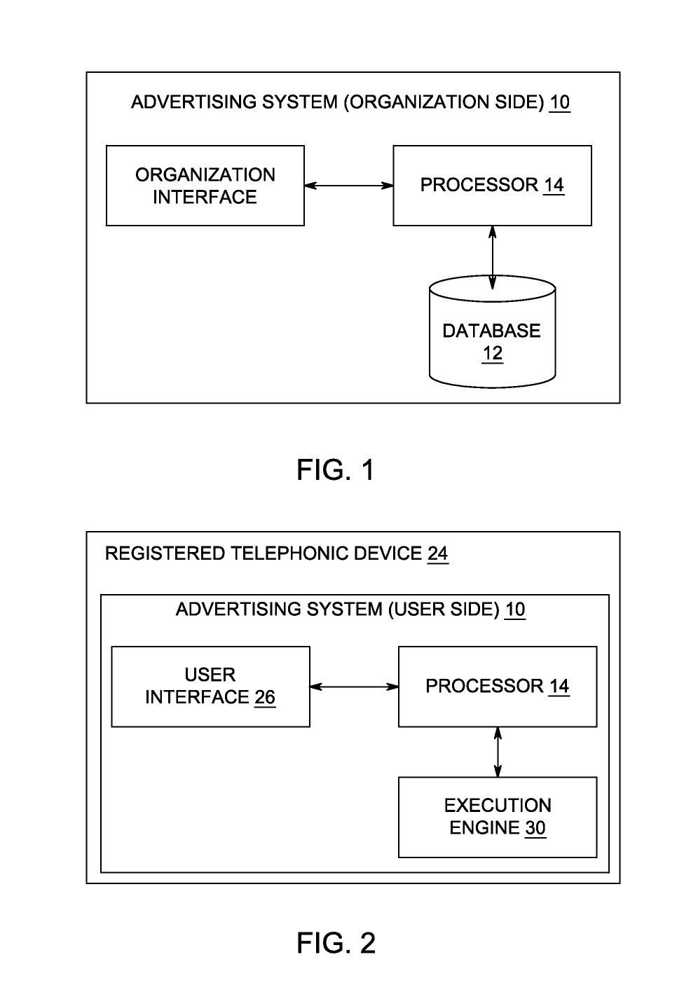

Referring to FIG. 1, the advertising system 10 comprises a database 12 comprising a plurality of advertising organization entries wherein, each advertising organization entry represents an advertising organization, i.e., an organization registered therewith. Each advertising organization entry is associated with at least one competitor organization entry, which represents an organization that is a business competition to the advertising organization. Each competitor organization entry is associated with at least one competitor telephone number, which comprises the telephone number thereof. The competitor organization entries and the corresponding competitor telephone numbers are provided by the advertising organization via a user interface provided by the advertising system. In another embodiment, an advertising organization only needs to provide the advertising system with the competitors thereof. The advertising system is configured such that, upon the mention of the competitors by the advertising organization, the telephone numbers pertaining to the competitor organizations are automatically tracked and populated within the database by the advertising system itself. Each advertising organization entry is further associated with at least one executable advertisement file, which is also provided by the corresponding advertising organization. Executing an advertisement file renders an advertisement, which, as discussed earlier, is basically a product/service purchase offer with an option to accept and reject the same.

Each advertisement file is further associated with an advertising phone number, which comprises the telephone number of the corresponding advertising organization. Each advertisement file is further associated with a threshold number, which represents the number of times the advertisement file is allowed to be retrieved from the database to be executed. The advertisement file that has not reached its threshold number will be referred to as an “active” advertisement file, while the advertisement file that has reached its threshold will be termed as an “inactive” advertisement file. In one embodiment, each advertisement is file is further associated with an expiry date wherein, an advertisement file within the expiry date thereof is termed as an “active” advertisement file, while the advertisement file that has reached the expiry date thereof will be referred to as an “inactive” advertisement file. In another embodiment, each advertisement file is further associated with a stock number, which represents the total stock of the product(s)/service(s) that the advertisement offers. An advertisement file is “active” as long as the product(s)/service(s) the advertisement offers are in stock. Once the product(s)/service(s) are out of stock, the corresponding advertisement file becomes “inactive.” Therefore, in the database, each advertisement file is identified to be “active” or “inactive” on the basis of the threshold number (the number of times the advertisement file has been retrieved so far), or the threshold number and the expiry date, or the threshold number, the expiry date and the stock number. An advertising organization entry that is associated with at least one active advertisement file is referred to as an active advertising organization entry. Therefore, similar to the advertisement files being marked as active and inactive, the advertisement entries are also marked as active and inactive within the database.

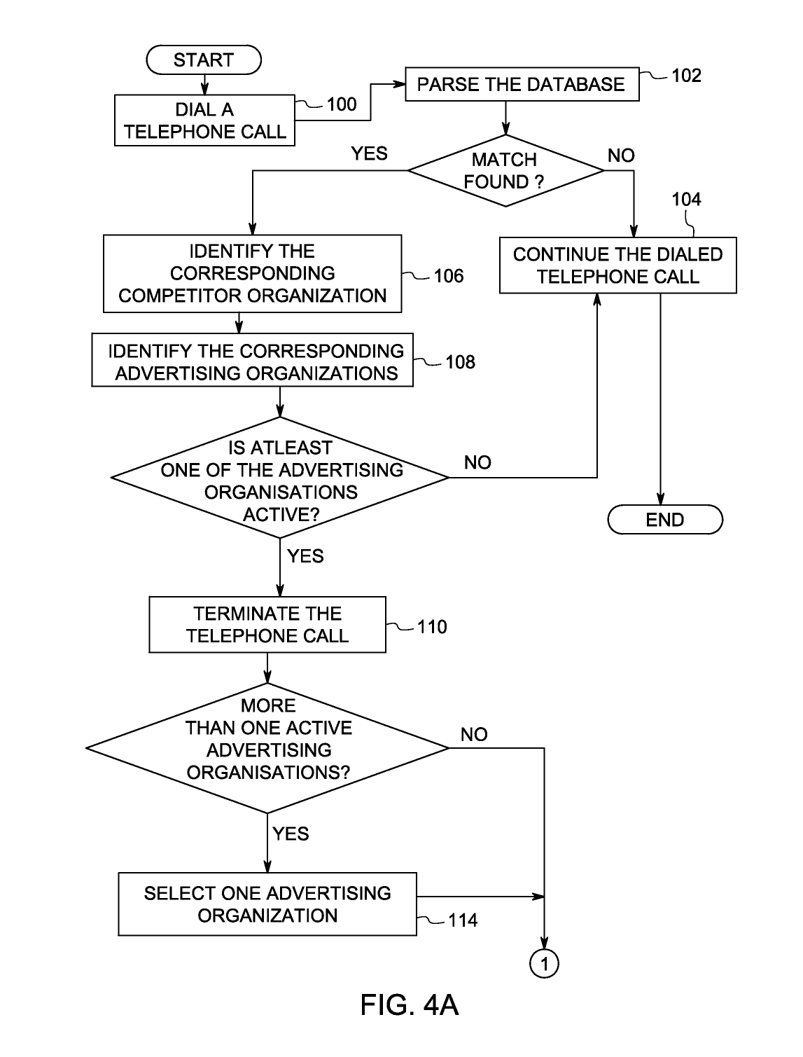

Referring to FIGS. 1 through 3, the advertising system 10 further comprises a processor 14, which is configured to be in communication with the database 12. For ease of understanding, the processor 14 is divided into a plurality of modules viz., a number module 16, a checking module 18, a call termination/initiation module 20, and a retrieval module 22 as seen in FIG. 3. The processor 14 is configured such that, when a number is dialed on a registered telephonic device 24 by a user via the user interface 26, the number module 16 proceeds to parse the database 12 for a match between the dialed number and a competitor telephone number. When no match is found, no action is taken by the advertising system 10 and the call to the dialed number proceeds uninterrupted. However, when a match is found, the checking module 18 proceeds to identify competitor organization to which the matched competitor telephone number pertains and the advertising organizations that have listed the competitor organization as a competitor. Of the advertising organizations that have been identified, the checking module 18 proceeds to identify active advertising organizations. If none of the advertisement organizations are found to be active, no action is taken by the advertising system 10 and the call to the dialed number proceeds uninterrupted. However, if there are active advertisement organizations, the telephone call to the dialed number is terminated by the call termination/initiation module 20. At this point, one of the active advertisement files pertaining to one of the active advertising organizations is retrieved from the database 12 as enabled by the retrieval module 22.

Referring to FIG. 3, the retrieval module 22 comprises a selection module 28 for selecting one active advertising organization and one active advertisement file when presented with a case where there is more one active advertising organization and more than one active advertisement file respectively to choose from. More particularly, if there is more than one active advertising organization to pick from, the selection module 28 is configured such that, the selection is based on the number of times an active advertising organization is chosen for the specific telephonic device. More particularly, the active advertising organization that has been chosen the least number of times is picked up by the selection module 28. In case of a match of count, a random selection is performed by the selection module 28. In another embodiment, the selection is based on the number of times an active advertising organization is chosen in general, not specific to the telephonic device. In yet another embodiment, an active advertising organization is picked from a plurality of active advertising organizations on the basis of bidding price. More particularly, whichever active advertising organization bids the highest price while purchasing an account with the advertising system will be given a selection priority. In this embodiment, the bidding price of each advertising organization is associated with the corresponding advertising organization entry in the database 12 as an entry.

Still referring to FIG. 3, in case of the situation where there is more than one active advertisement file listed for the selected active advertising organization, the active advertisement file that has been retrieved the least number of times is picked up by the selection module 28. In case of a match in the count, as in the earlier scenario, a random selection is performed. In another embodiment, the selection is based on the number of times an active advertisement file is chosen in general, not specific to the telephonic device. In yet another embodiment, the question of choosing which active advertisement file is based on the duration for which, the active advertisement files in question are played. More particularly, the advertisement has been played for the least amount of time is chosen. In case of a plurality of advertisements sharing same duration, an active advertisement file may be randomly picked by the selection module 28. Once an active advertisement file is retrieved by the retrieval module 22, the corresponding threshold number is reduced accordingly and the change is reflected in the database 12.

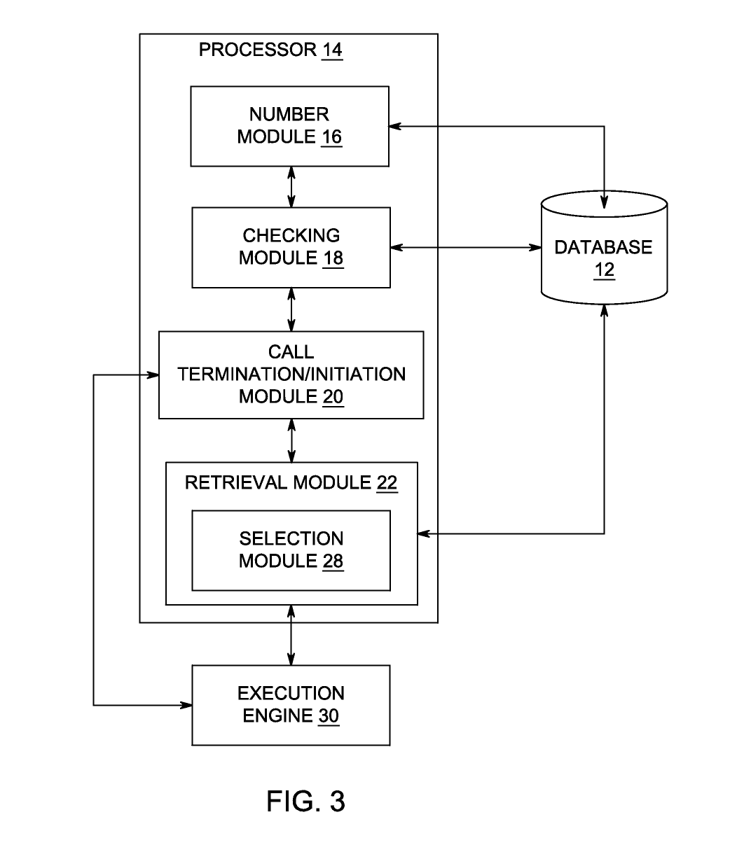

Referring to FIGS. 2 and 3, the advertising system further comprises an execution engine 30 for executing the advertisement file that is retrieved by the retrieval module 22. The advertisement file is preferably an audio file that is encoded in any digital audio format known in the art. In another embodiment, the advertisement file may comprise an image file or even a multimedia file. The advertisement, more particularly, comprises a product/service purchase offer with an advertisement interface to enable the user to “accept” and “reject” the same as mentioned earlier. More particularly, the advertisement interface comprises the physical or virtual keypad of the telephonic device wherein, the acceptance or rejection of the user is conveyed through the pressing the designated keys on the physical or virtual keypad of the telephonic device. The execution engine 30 could be any media player capable of executing advertisement file resulting in the rendering thereof. The execution engine 30 is associated with the call termination/initiation module 20 as shown in FIG. 3 such that, when the advertisement is rejected or when run of the advertisement is complete, the telephone call to the earlier dialed competitor telephone number is reinitiated. However, if the product(s)/service(s) offer is accepted by the user by pressing an appropriate key, the telephone call to the corresponding advertising telephone number is initiated by the call termination/initiation module 20. The user will be guided on how to avail the product/service offer when the telephone call to the advertising telephone number is connected. In case of the earlier discussed embodiment where the database 12 includes the stock number, when a product(s)/service(s) offer is availed by the user, the stock number associated with the advertisement file accordingly deducted and the same is reflected in the database 12. Usage data is collected and stored in the database 12 for analysis and generating reports. More particularly, the usage data include the time of the call, the telephone number called, whether a product/service offer has been accepted or rejected, and etc.

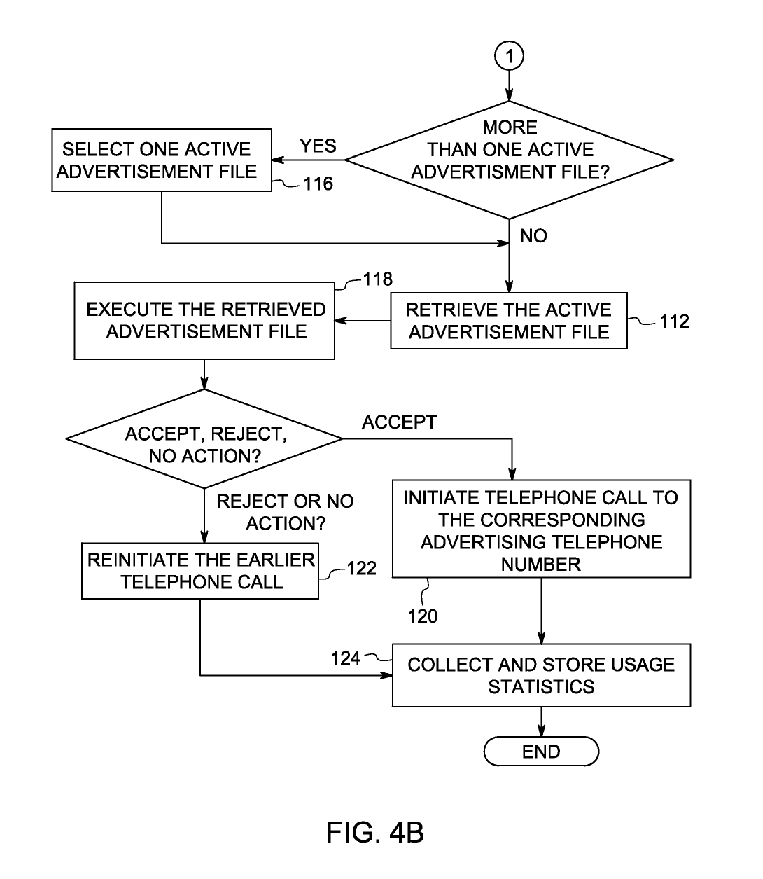

Referring to the flowchart of FIGS. 4A and 4B, the advertising method of the present invention is initiated with dialing a telephone call (step 100) on a registered telephonic device of a user. The dialed number is taken up by the number module to parse the database (step 102) for a match between the dialed number and a competitor telephone number. If no match is found, the telephone call to the earlier dialed telephone number is proceeded uninterrupted (step 104). However, if a match is found between the dialed number and a competitor telephone number, the checking module proceeds to identify the competitor organization (step 106) to which the competitor telephone number pertains. Upon identifying the competitor organization, the advertising organizations that have listed the competitor organization are identified (step 108). At this point the checking module determines whether or not the identified advertising organizations include at least one active advertising organization. If none of the identified advertising organizations include an active advertising organization, the telephone call to the dialed number is carried out uninterrupted (step 104). However, on the other hand, if at least one active advertising organization is identified, the telephone call to the dialed number is terminated (step 110) by the call termination/initiation module. Upon the termination, one of the active advertisement files pertaining to one of the active advertising organizations is retrieved from the database as enabled by the retrieval module.

Still referring to FIGS. 4A and 4B, if only one active advertising organization has listed the competitor organization as a competitor therefor, and if there is only one active advertisement file that pertains thereto, the active advertisement file is retrieved by the retrieval module (step 112). However, if more than one active advertising organization has listed the competitor organization as a competitor therefor, one active advertising organization is selected by the selection module (step 114), which is a part of the retrieval module. More particularly, the selection is based on the number of times an active advertising organization is chosen for the specific telephonic device. More particularly, the active advertising organization that has been chosen the least number of times is picked up by the selection module. In case of a match of count, a random selection is performed by the selection module. In another embodiment, the selection is based on the number of times an active advertising organization is chosen in general, not specific to the telephonic device. In yet another embodiment, an active advertising organization is picked from a plurality of advertising organizations on the basis of bidding price. More particularly, whichever active advertising organization bids the highest price while purchasing an account with the advertising system will be given a selection priority.

Still referring to FIGS. 4A and 4B, if a selected active advertising organization is associated with a single active advertisement file, the same is retrieved from the database by the retrieval module (step 112). However, if there is more than one active advertisement file to choose from, the choice is again made by the selection module to pick one active advertisement file from the plurality of the same (step 116). More particularly, the active advertisement file that has been retrieved the least number of times is picked up by the selection module. In case of a match in the count, as in the earlier scenario, a random selection is performed. In another embodiment, the selection is based on the number of times an active advertisement file is chosen in general, not specific to the telephonic device. In yet another embodiment, the solution of choosing which active advertisement file is based on the duration for which, the active advertisement files in question are played. More particularly, the advertisement has been played for the least amount of time is chosen. In case of a plurality of advertisements sharing same duration, an active advertisement file may be randomly picked by the selection module.

Still referring to FIGS. 4A and 4B, once the selection of an appropriate active advertisement file is made the selection module (step 116), the advertisement file is retrieved by the retrieval module (step 112). At this point, the retrieved advertisement file is handed over to the executive engine, which is disposed within the telephonic device, to execute the same (step 118) so as to ‘play’ an advertisement on the telephonic device. The advertisement is basically comprises a product(s)/service(s) purchase offer with option to “accept” and “reject” the same. When the user chooses to accept the offer, the advertising telephone number associated with the advertisement file is automatically dialed (step 120) as enabled by the call termination/initiation module wherein, when the call is connected, the user is guided on how to purchase the product(s)/service(s) that is offered. However, if the user rejects the offer or once the advertisement has completed its run, the call to the earlier dialed competitor telephone number is reinitiated (step 122) by the call termination/initiation module. Usage data is collected and stored in the database (step 124) for analysis and generating reports. More particularly, the usage data include the time of the call, the telephone number called, whether a product/service offer has been accepted or rejected, and etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A computer-implemented mobile advertising system comprising:
(a) a database comprising a plurality of advertising organization entries wherein, an advertising organization entry represents an advertising organization, each advertising organization entry associated with at least one competitor telephone number and at least one executable advertisement file, an advertisement file comprising either an active or an inactive advertisement file, and an advertising organization entry associated with at least one active advertisement file referred to as an active advertising organization entry;
(b) a processor in communication with the database, the processor for retrieving, upon determining that a number, a user dialed on a telephonic device is a competitor telephone number associated with at least one active advertising organization, an active advertisement file out of the at least one active advertisement file that corresponds to one of the at least one active advertising organization to which the competitor telephone number is associated; and
(c) an execution engine disposed within the telephonic device, the execution engine for executing the retrieved active advertisement file so as to play an advertisement on the telephonic device.

2. The advertising system of claim 1 wherein, the processor is further configured to terminate the telephone call to the user-dialed number upon determining that the user-dialed number is a competitor telephone number associated with at least one active advertising organization.

3. The advertising system of claim 1 wherein, each advertisement file in the database is associated with a threshold number, which represents the number of times an advertisement file is allowed to be retrieved; an advertisement file that has not been retrieved as many times as the threshold number thereof referred to as an active advertisement file and an advertisement file that has been retrieved as many times as the threshold value thereof referred to as an inactive advertisement file.

4. The advertising system of claim 3 wherein, each advertisement file in the database is further associated with an expiry date, which represents the calendar date on which, the advertisement rendered by the execution of an advertisement file expires, an advertisement file, which has not reached the expiry date thereof and which has not been retrieved as many times as the threshold number thereof referred to as an active advertisement file and an advertisement file, which has reached the expiry date thereof or which has been retrieved as many times as the threshold value thereof referred to as an inactive advertisement file.

5. The advertising system of claim 1 wherein, each advertisement file in the database is associated with at least one advertising telephone number.

6. The advertising system of claim 5 wherein, the advertisement comprises a product/service purchase offer comprising an advertisement interface to accept or reject the same, accepting the offer results in one of the corresponding at least one advertising telephone number being automatically dialed from the telephonic device.

7. The advertising system of claim 6 wherein, the advertisement interface comprises the physical or virtual keypad of the telephonic device.

8. The advertising system of claim 6 wherein, each advertisement file in the database is associated with a stock number, which represents the total number of stock of the product or service the advertisement rendered by an advertisement file offers for purchase; an advertisement file, the product or service of which is out of stock referred to as an inactive advertisement.

9. The advertising system of claim 6 wherein, the processor is further configured to reinitiate the user-dialed telephone call, which has been previously terminated upon determining that the user-dialed number is a competitor telephone number associated with at least one active advertising organization, upon the completion or rejection of the advertisement.

10. The advertising system of claim 1 wherein, the advisement comprises audio content.

11. The advertising system of claim 1 wherein the processor comprises a selection module for selecting an active advertising organization for retrieval out of a plurality of active advertising organizations, the selection made in the case where the competitor telephone number is associated with the plurality of active advertising organizations, the selection based on the number of times each of the plurality of active advertising organizations have been previously selected from the database.

12. The advertising system of claim 1 wherein the processor comprises a selection module for selecting an active advertising organization for retrieval out of a plurality of active advertising organizations, the selection made in the case where the competitor telephone number is associated with the plurality of active advertising organizations, the selection based on the bidding price bid by each of the plurality of active advertising organizations; the bidding price of each advertising organization associated with the corresponding advertising organization entry within the database.

13. The advertising system of claim 1 wherein the processor comprises a selection module for selecting an active advertisement file for retrieval out of a plurality of active advertisement files, the selection made in the case an active advertisement organization is associated with the plurality of advertisement files, the selection based on the number of times each of the plurality of active advertisement files have been previously retrieved from the database.

14. The advertising system of claim 1 wherein, an advertising organization comprises an organization registered therewith.

15. A computer-implemented mobile advertising system comprising:
(a) a database comprising a plurality of advertising organization entries wherein, an advertising organization entry represents an advertising organization registered therewith, each advertising organization entry associated with at least one competitor telephone number and at least one executable advertisement file, an advertisement file comprising either an active or an inactive advertisement file, and an advertising organization entry associated with at least one active advertisement file referred to as an active advertising organization entry, each advertisement file associated with an advertising telephone number;
(b) a processor in communication with the database, the processor for retrieving, upon determining that a number, a user dialed on a telephonic device is a competitor telephone number associated with at least one active advertising organization, an active advertisement file out of the at least one active advertisement file that corresponds to one of the at least one active advertising organization to which the competitor telephone number is associated, the processor to terminate the telephone call to the user-dialed number upon determining that the user-dialed number is a competitor telephone number associated with at least one active advertising organization, the processor comprising a selection module for selecting an active advertisement file for retrieval out of a plurality of active advertisement files, the selection made in the case an active advertisement organization is associated with the plurality of advertisement files, the selection based on the number of times each of the plurality of active advertisement files have been previously retrieved from the database; and
(c) an execution engine disposed within the telephonic device, the execution engine for executing the retrieved active advertisement file so as to play an advertisement on the telephonic device.

16. A computer-implemented mobile advertising method comprising:
(a) listing a plurality of advertising organization entries within a database wherein, an advertising organization entry represents an advertising organization, each advertising organization entry associated with at least one competitor telephone number and at least one executable advertisement file, an advertisement file comprising either an active or an inactive advertisement file, and an advertising organization entry associated with at least one active advertisement file referred to as an active advertising organization entry;
(b) determining that a number, a user dialed on a telephonic device is a competitor telephone number associated with at least one active advertising organization;
(c) retrieving an active advertisement file out of the at least one active advertisement file that corresponds to one of the at least one active advertising organization to which the competitor telephone number is associated; and
(d) executing the retrieved active advertisement file so as to render an advertisement on the telephonic device.

17. The advertising method of claim 16 further comprising terminating the telephone call to the user-dialed number upon determining that the user-dialed number is a competitor telephone number associated with at least one active advertising organization.

18. The advertising method of claim 16 wherein, each advertisement file in the database is associated with a threshold number, which represents the number of times an advertisement file is allowed to be retrieved; an advertisement file that has not been retrieved as many times as the threshold number thereof referred to as an active advertisement file and an advertisement file that has been retrieved as many times as the threshold value thereof referred to as an inactive advertisement file.

19. The advertising method of claim 18 wherein, each advertisement file in the database is further associated with an expiry date, which represents the calendar date on which, the advertisement rendered by the execution of an advertisement file expires, an advertisement file, which has not reached the expiry date thereof and which has not been retrieved as many times as the threshold number thereof referred to as an active advertisement file and an advertisement file, which has reached the expiry date thereof or which has been retrieved as many times as the threshold value thereof referred to as an inactive advertisement file.

20. The advertising system of claim 16 wherein, each advertisement file in the database is associated with at least one advertising telephone number.

21. The advertising method of claim 20 wherein, an advertisement comprises a product/service purchase offer comprising an advertisement interface to accept or reject the same, accepting the offer results in one of the corresponding at least one advertising telephone number being automatically dialed from the telephonic device.

22. The advertising method of claim 21 wherein, the advertisement interface comprises the physical or virtual keypad of the telephonic device.

23. The advertising method of claim 21 wherein, each advertisement file in the database is associated with a stock number, which represents the total number of stock of the product or service the advertisement rendered by an advertisement file offers for purchase; an advertisement file, the product or service of which is out of stock referred to as an inactive advertisement.

24. The advertising method of claim 21 further comprising reinitiating the user-dialed telephone call, which has been previously terminated upon determining that the user-dialed number is a competitor telephone number associated with at least one active advertising organization, upon the completion or rejection of the advertisement.

25. The advertising method of claim 16 wherein, the advisement comprises audio content.

26. The advertising method of claim 16 further comprising selecting an active advertising organization for retrieval out of a plurality of active advertising organizations, the selection made in the case where the competitor telephone number is associated with the plurality of active advertising organizations, the selection based on the number of times each of the plurality of active advertising organizations have been previously selected from the database.

27. The advertising method of claim 16 further comprising selecting an active advertising organization for retrieval out of a plurality of active advertising organizations, the selection made in the case where the competitor telephone number is associated with the plurality of active advertising organizations, the selection based on the bidding price bid by each of the plurality of active advertising organizations; the bidding price of each advertising organization associated with the corresponding advertising organization entry within the database.

28. The advertising method of claim 16 further comprising selecting an active advertisement file for retrieval out of a plurality of active advertisement files, the selection made in the case an active advertisement organization is associated with the plurality of advertisement files, the selection based on the number of times each of the plurality of active advertisement files have been previously retrieved from the database.

29. The advertising method of claim 16 wherein, an advertising organization comprises an organization registered therewith.

30. A computer-implemented mobile advertising method comprising:
(a) listing a plurality of advertising organization entries within a database wherein, an advertising organization entry represents an advertising organization registered therewith, each advertising organization entry associated with at least one competitor telephone number and at least one executable advertisement file, an advertisement file comprising either an active or an inactive advertisement file, and an advertising organization entry associated with at least one active advertisement file referred to as an active advertising organization entry, each advertisement file associated with an advertising telephone number;
(b) determining that a number, a user dialed on a telephonic device is a competitor telephone number associated with at least one active advertising organization;
(c) terminating the telephone call to the user-dialed number upon determining that the user-dialed number is a competitor telephone number associated with at least one active advertising organization;
(d) retrieving an active advertisement file out of the at least one active advertisement file that corresponds to one of the at least one active advertising organization to which the competitor telephone number is associated; and
(e) executing the retrieved active advertisement file so as to render an advertisement on the telephonic device.
